(19) United States
(12) Patent Application Publication
(10) Pub. No.: US 2009/0015682 A1
(43) Pub. Date: Jan. 15, 2009

(54) Anti-glare device, method and accessory, and imaging system with increased brightness dynamics

(75) Inventor: Jean-Loup Chretien, Morlaix (FR)

Correspondence Address: BANNER & WITCOFF, LTD., 1100 13th STREET, N.W., SUITE 1200, WASHINGTON, DC, 20005-4051, US

(73) Assignee: TIETRONIX OPTICS, LANNION (FR)

(21) Appl. No.: 10/584,248

(22) PCT Filed: Dec. 27, 2004
(86) PCT No.: PCT/FR2004/003390

§ 371 Date: Jun. 22, 2006

(30) Foreign Application Priority Data
Dec. 26, 2003 (FR) 0315467

(51) Int. Cl. H04N 5/228; G06K 9/40

(52) U.S. Cl. 348/222.1; 382/261; 348/E05.031

(57) ABSTRACT

The invention relates to an anti-glare device comprising a camera, a visualisation means for reproducing a processed image, and an adaptable filter comprising a filtering image controlled by the camera, said image containing masking regions which obscure the dazzling regions. The inventive device is characterised in that it comprises a single camera provided with an output connected to an electronic circuit which controls the filter for the alternate display of an acquisition image and a filtration image calculated according to the image transmitted by the camera during the previous acquisition phase. The invention also relates to the method implemented by one such device, and to an accessory for a photographing device.

The present invention relates to a device and a method for modulating an image received by an image sensor in order to avoid the glare from intense sources and increase the brightness dynamics.

Such devices can form active sun visors for automobiles, boats or aircraft, or observation means enhanced for night vision or security. The method can also be applied to improve a cinematographic or photographic device.

The prior art includes US patent application US020071185. This patent describes a system and a method of dynamic optical filtering which blocks the intense light sources without affecting the rest of the scene. A sensor measures the intensity and the position of the light so that the selected cells of a filtering matrix mask the or each intense light source. The incident image passes through a beam splitter transmitting a portion to said sensor, and the other portion to an exposure camera placed behind the filtering matrix.

Also representative of the prior art is US patent US2002/012064. This patent does not relate to the acquisition of moving pictures, but photographic applications. The problem is therefore different since there is no ongoing and real-time recalculation of a variable image. Moreover, this document does not disclose the characteristic concerning the position of the active filter in the focal plane of the input lens.

U.S. Pat. No. 4,918,534 relates to a device intended for medical imaging for scenes corresponding to recovery by an image intensifier. This document does not disclose the characteristic concerning the position of the optical filter in the focal plane.

This solution of the prior art involves the use of a sensor for analyzing the unprocessed image, and a camera for acquiring the image processed by the filter. The beam splitter reduces the brightness of the image acquired by the camera. The object of the invention is to propose a technical solution rectifying these drawbacks, in order to make it possible to produce a more compact and less expensive device, exhibiting superior optical qualities.

To this end, the invention relates, according to its widest meaning, to an anti-glare device comprising an image sensor, a visualization means for reproducing the image and an adaptable light modulator presenting a filtering modulation controlled by said image sensor, said modulation presenting masking regions obscuring or attenuating the glare regions, characterized in that it comprises a single image sensor handling both the analysis function for controlling the adaptable light modulator and the function for recording the modulated image.

The term “image sensor” is used in this patent to signify a means of acquiring an image in the light spectrum, and delivering an electrical signal. This is, in particular and not exclusively, a charge-coupled device, CCD, a microbolometer matrix, a cathode ray tube camera, a charge-multiplying sensor.

The term “light modulator” is used in this patent to signify a means presenting transmission or reflection regions that are variable and controlled by an electrical signal, which is inserted into the field of view of the image sensor. It can be, for example, a liquid crystal screen or an MEMS type micromirror array. The “transmission rate” of the light modulator is understood in this patent to be the fraction of the light that the modulator transmits to the image sensor, whatever its modulation type (transmissive, reflective, transreflective, etc). Vtmax denotes the maximum transmission rate of the modulator (“white”). Vtmin denotes the minimum transmission rate of the modulator (“black”). Vtmax/Vtmin=c, with c>1.

The term “analysis mode” is used in this patent to signify the situation where the electrical signal delivered by the image sensor is intended to be used for the generation of the modulation signal controlling the light modulator.

The term “recording mode” is used in this patent to signify the situation where the electrical signal delivered by the image sensor is intended to be used for the generation of the signal to the visualization means, for the recording or reproduction of a modulated image, typically on a video monitor, a projection screen, etc.

According to a first embodiment, the output of the image sensor is connected to an electronic circuit controlling the modulator alternately for a modulation for analysis purposes and for a modulation for filtration purposes calculated according to the image seen by the image sensor during the previous analysis phase and active during the recording phase.

Advantageously, the circuit disables the transmission of the electrical signal from the image sensor to the visualization means during the analysis phases.

Preferably, the electronic circuit transmits to the visualization means, during the analysis phases, a prerecorded image corresponding to the image transmitted by the image sensor before the analysis phase.

According to a variant, the electronic circuit controls the light modulator during the analysis phase, so that it presents a uniform transmission rate over the entire surface area, with a transmission value corresponding to a value Vt less than 1.

According to a particular embodiment, said value Vt is determined according to the brightness of at least one previous image.

According to a first variant, the light modulator is a liquid crystal filter.

According to another variant, said light modulator is a reflection filter.

According to a third variant, said light modulator is a transmission filter.

Preferably, said light modulator is placed in the focal plane of an input lens.

According to a particular embodiment, the light modulator is a steerable micromirror filter.

According to a preferred variant, the light modulator has a maximum transmission rate that is uniform over the entire surface area in a waveband.

Preferably, said waveband corresponds to the red.

Advantageously, the light modulator has a transmission rate that is adjustable in a waveband.

According to a variant, said waveband is the 750 nm-1400 nm band.

The invention also relates to a method of processing an image acquired by an image sensor, comprising a step for filtering by a light modulator controlled by a periodically re-evaluated masking image, characterized in that it comprises, alternately, a step for acquiring an image and analyzing said image to prepare a masking image, and a filtering step during which the image is acquired by the image sensor after insertion of said light modulator controlled by the previously re-evaluated masking image, the steps for acquiring images to control the light modulator and for reproducing the corrected image being performed by the same image sensor.

Advantageously, the images reproduced during the analysis step correspond to a previous corrected image.

Preferably, the analysis step is performed in a time less than the retinal persistence time.

The invention also relates to an accessory of a photographic or video exposure device, for correcting the image acquired by an image sensor, characterized in that it comprises an active light modulator controlled by a filtering image periodically re-evaluated by a circuit receiving the image acquired by the image sensor and periodically controlling the presentation by the light modulator of a reference filtering image during the analysis phases.

According to a variant, the circuit also disables the link between the image sensor and the output of the exposure device during the analysis phases.

The invention will be better understood from reading the description that follows, referring to a non-limiting exemplary embodiment, in which:

FIG. 1 represents the optical diagram of a device according to the invention,

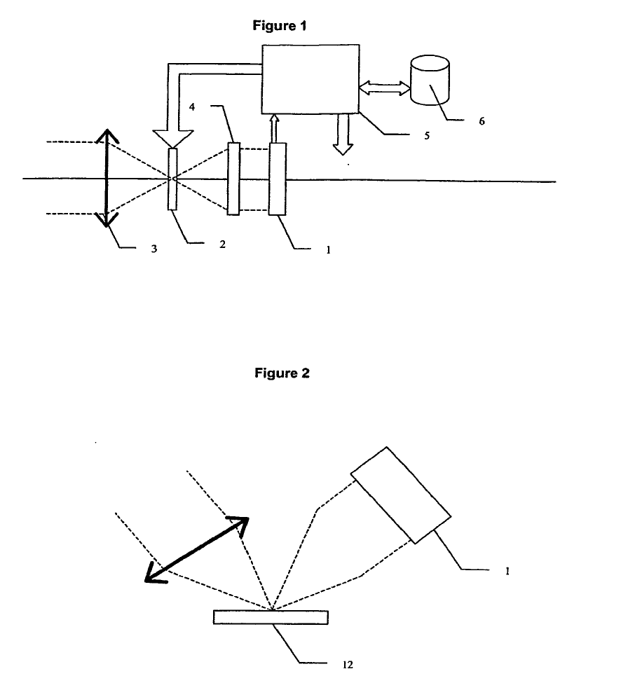

FIG. 2 represents a view of an embodiment variant,

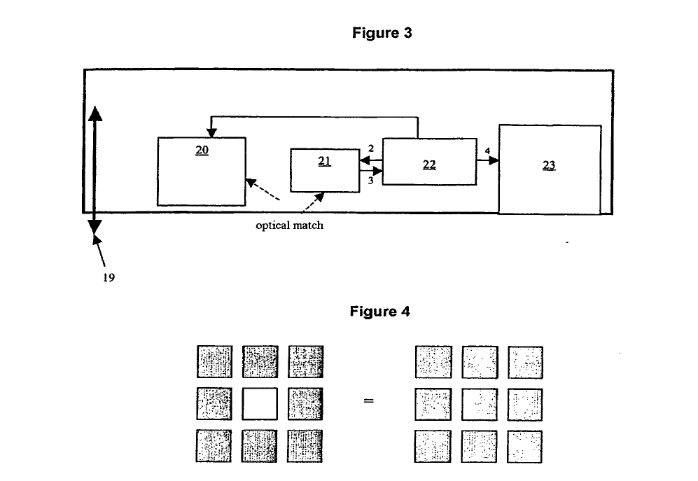

FIG. 3 represents the general architecture of a device according to the invention,

FIG. 4 represents a schematic view of a modulator implemented by the invention,

FIG. 5 represents the theoretical block diagram of the electronic circuit,

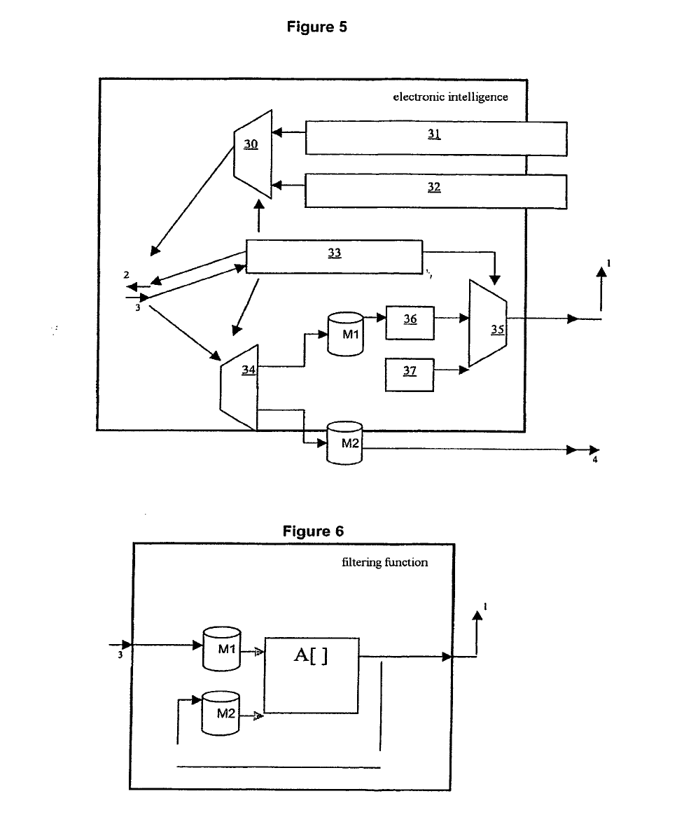

FIG. 6 represents the theoretical block diagram of the filtering module,

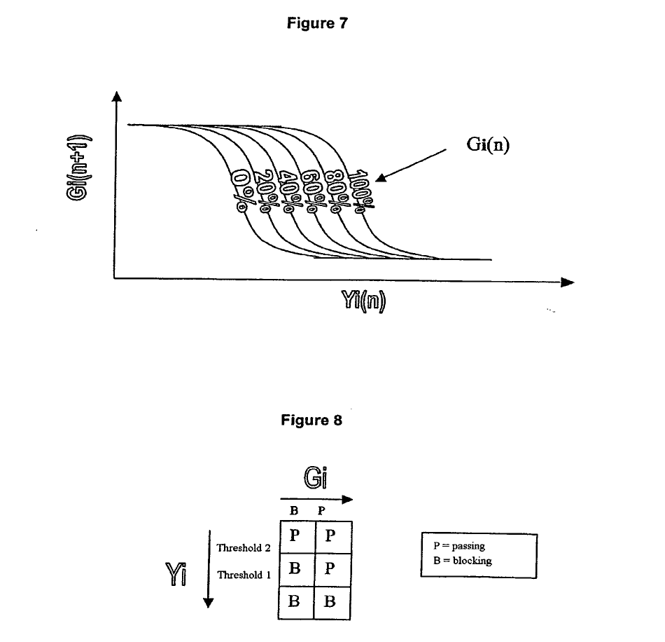

FIG. 7 represents the response curve of the filtering function,

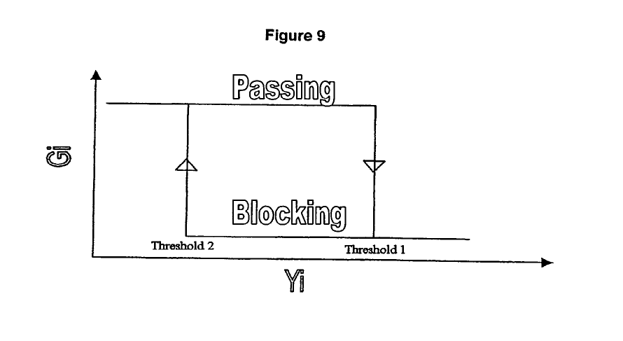

FIGS. 8 and 9 represent the thresholding table and the corresponding response curve,

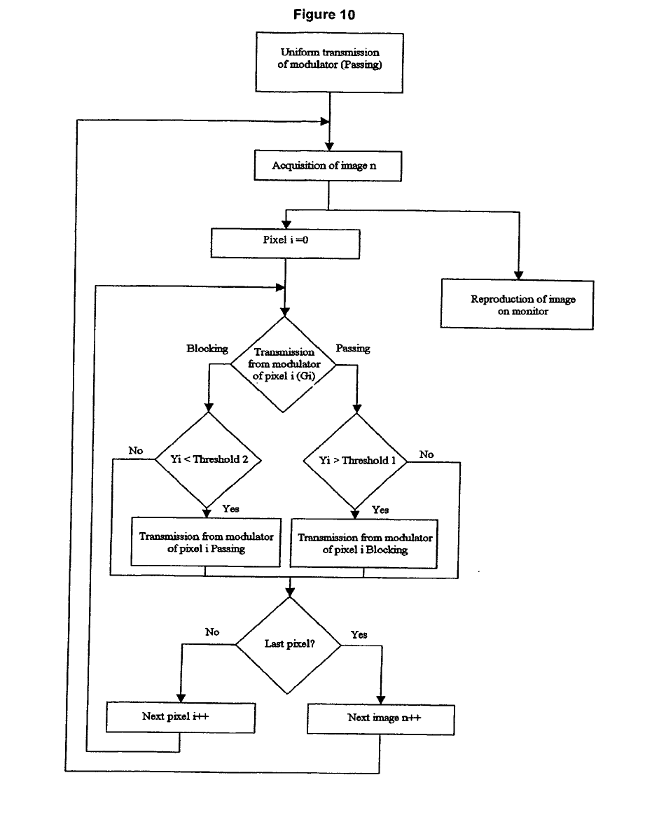

FIG. 10 represents the operating algorithm of the device,

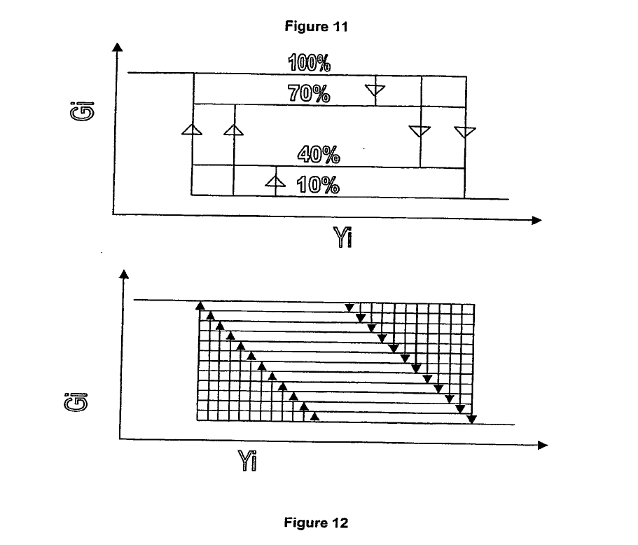

FIGS. 11 and 12 represent the thresholding table and the corresponding response curve for a variant with several threshold levels.

The device according to the invention comprises an image sensor (1), for example the sensor of a digital video camera or a digital photographic apparatus. An adaptive light modulator (2) is inserted on the optical path. It is placed in the image plane of an input lens (3) focusing the observed image in the plane of the light modulator (2). An output optical system (4) is placed between the light modulator (2) and the optical system of the camera. It is, of course, possible to combine the output optical system (4) and the optical system of the exposure device in a single optical block.

A computer (5) is linked to the output of the image sensor (1). It controls the adaptive light modulator (2) and the video output of the device. In the example described, it includes a video memory.

The computer periodically carries out the following functions:

1—Analysis: during this step, the computer (5) controls the light modulator (2) for the formation of a reference masking image, for example a filtering image exhibiting a uniform filtering rate over the entire surface area of the light modulator, to produce a uniform gray filter. This uniform filtering rate can be variable, and literally translated by a color, ranging from white (zero filtering or maximum transmission) to black (maximum filtering or minimum transmission). The output of the image sensor (1) delivers an image with an overall reduced brightness level.
2—Evaluation of a new masking image. During this step, the computer determines the high intensity regions to calculate a new masking image. The regions with a brightness exceeding a threshold value will be totally or partially masked.
3—Acquisition of a filtered image: the computer (5) sends to the light modulator (2) a re-evaluated filtering image, and the light modulator presents a configuration totally or partially obscuring the high intensity regions. The image acquired by the sensor (1) is transmitted to the video output for visualization of a processed image.

During the steps 1 and 2, the image available on the video output can comprise an image recorded in a video memory (6), corresponding to the previous processed image.

The duration of the steps 1 and 2 is less than the retinal persistence time.

The cycle is preferably carried out at a rate of greater than 25 processes per second.

The reference image controlling the light modulator during the step 1 is a constant transmission image, the level of which can, if necessary, be adjusted by analysis of the intensities of the images of the preceding cycles. This variant makes it possible to optimize the brightness level of the images during the steps 1 and 2, and improve thresholding efficiency. It is also possible to provide non-uniform reference images, presenting a lower transmission rate in the regions with a super-brightness probability determined on the basis of the information available on the prior images. In this case, the calculation of the masking image will take into account the profile of the reference image for the calculation of the new masking image.

The masking can depend on the wavelength: for automobile applications, it is, for example, proposed to allow, in all circumstances, a high or even maximum transmission rate in the wavebands corresponding to security signals, for example, in the red corresponding to stop lights and traffic lights.

FIG. 2 represents a view of the optical diagram of an embodiment variant implementing a reflection light modulator and not a transmission light modulator. The light modulator (12) is made up of micromirrors, the orientation of which is controlled between a position of reflection towards the image sensor and a position of dispersion or reflection towards a light trap. The micromirrors corresponding to the regions of high light intensity are controlled to scatter the incident beam or redirect it to a light trap, whereas the other micromirrors are oriented to reflect the incident beam towards the image sensor (1).

FIG. 3 represents the general architecture of a device according to the invention.

The device conventionally comprises an input optical system (19) forming an image in the focal plane of a light modulator (20) and an image sensor (21) driven by an electronic control circuit (23).

The control circuit (23) drives the operation of the light modulator (20) and the image sensor (21), and delivers the video signal intended for the visualization means.

The control circuit (23) ensures the match between the light modulator and the image sensor, which are normally in matrix form. The optical match between the two ensures a correlation between a group of pixels Mi of the light modulator and a group of pixels Ci of the image sensor.

In an embodiment, the light modulator has a resolution of 960×720, the image sensor has a resolution of 640×480 (VGA).

This light modulator is divided into groups of pixels made up of 3×3 pixels, or 320×240 groups of pixels Mi (i varying from 1 to 76800) as diagrammatically represented in FIG. 4.

This image sensor is divided into as many groups of pixels Ci optically corresponding with the groups of pixels Mi of the light modulator (or of the Ci comprising 2×2 pixels).

Definition of the signals Gi of the light modulator

The transmission rate of the group of pixels Mi of the light modulator is equal to Vti=Vtmax×Gi, where Gi is the gray level of the group of pixels Mi of the light modulator.

Gi varies from the value Vtmin/Vtmax when it concerns the “black” level, to 1 when it concerns the “white” level. Gi therefore varies from 1/c to 1.

Definition of the signals Yi of the image sensor

The luminance of the group of pixels Ci of the image sensor is determined according to the luminance of each of the constituent pixels (depending on the implementation method, it may be the maximum of the values of the group or the average of the values of the group or the value of a preferred pixel in the group).

It is equal to Li=Lmax×Yi, where Yi varies from the value Lmin/Lmax to 1.

Lmin and Lmax are respectively the minimum and maximum luminances of the image sensor, they depend on the current operating mode for the image sensor (shutter time, etc). The following expression also applies: Lmax/Lmin=d, with d>1.

Yi therefore varies from 1/d to 1.

Transmission Rate of a Group of Pixels

The transmission rate Vti of the group of pixels Mi of the light modulator depends in particular on the transmission rates of each of the pixels that make up the group.

According to an embodiment, Vti is produced by uniformly setting all the pixels of Mi.

According to another embodiment, Mi is made up of 3×3 pixels. Vti is produced by setting the central pixel to Vtmax and the eight other pixels to one and the same value making the resultant over the nine pixels Vti, as diagrammatically represented in FIG. 4.

According to a variant, the light modulator is made up of a matrix of micromirrors.

The use of a matrix of micromirrors as the light modulator presents a number of advantages:
Vtmax is high.
c is high.
Modulation times are fast.

The Gi can be set using time modulation rates (duty cycles).

The modulator can be driven according to two operating modes.

According to the first operating mode, the device operates alternately in “analysis mode” and in “recording mode”.

According to the second operating mode, the “analysis mode” is concurrent with the “recording mode”.

In the first operating mode, a cycle comprises a period containing an analysis phase followed by a recording phase.

Ideally, since the recording mode is the effective mode, the latter lasts longer than the analysis mode.

The core of the device is the electronic intelligence circuit (22) which synchronizes the various elements and which manages all the signals according to the mode (analysis or recording).

### Exemplary Implementation: Description of Five Families of Signals for a Complete Cycle

### In Analysis Mode:

Step 1: The electronic circuit (22) controls the light modulator to present a uniform transmission rate over the entire surface area equal to Vtan=Vtmax×Gan with Gan smaller than 1.

In an embodiment, Gan= 1/100.

Step 2: The electronic circuit controls the shutter time of the image sensor to a fraction of the shutter time of the recording mode of the preceding cycle (or to a predefined startup value, if it is the first cycle): Tshutteran=Tshutterrec×Tan with Tan smaller than 1.

According to a preferred case, every effort is made to set Gan and Tan such that the product of Gan×Tan is as great as possible and less than or equal to 1/c. According to the best case, Gan×Tan=1/c.

In an embodiment, Tan= 1/10.

Step 3: The electronic circuit acquires the signal from the image sensor. It processes this information with an operating algorithm and the other parameters in its possession (including the control parameters with which it is controlling the light modulator and the image sensor). The result of this processing will then be used in the following recording phase.

Step 4: The electronic circuit informs that the current mode is the analysis mode and does not transmit information from the image sensor.

Step 5: The signal transmitted to the visualization means is a reproduction of the signal transmitted to the visualization means at the end of the preceding recording phase.

### In Recording Mode:

Step 1: The electronic circuit controls the light modulator to present a filtering modulation calculated when processing the signals “3” of the preceding analysis phase.

Step 2: The electronic circuit controls the parameters of the image sensor (shutter time, gain, etc). These parameters are calculated when processing the signals of step 3 of the preceding analysis phase.

Step 3: The electronic circuit acquires the signal from the image sensor.

Step 4: The electronic circuit transmits the signal from the image sensor and the values of the control parameters with which it is controlling the light modulator and the image sensor.

Step 5: The signal transmitted to the visualization means is produced from the data of the signals of step 4.

Example of Processing within the Electronic Circuit: Link Between Gi in Recording Mode and Yi in Analysis Mode

As detailed in the preceding section in the description of the signals of step 3 in analysis mode and step 1 in recording mode, the filtering modulation in a recording phase is dependent in particular on the signal from the image sensor of the preceding analysis phase. This means that Gi in a recording phase is, in particular, dependent on Yi from the preceding analysis phase.

The relationship between this Gi and this Yi is one of the important aspects of the operation of the electronic circuit. This relationship or “filtering transfer function” is symbolized by: Gi=F(Yi).

It can be a mapping table of the type of a single “look-up table” recorded in the electronic circuit, either programmable by the user or chosen by the electronic circuit (within a catalog of tables recorded in its memory) according to parameters.

It can be a function with conditions. In an implementation:

If Yi<Gan×Tan then Gi=1
If Yi>Gan×Tan then Gi=Gan×Tan/Yi
If Yi>c×Gan×Tan then Gi=1/c

It can be a direct function.

In an implementation, the function is: Gi=Gan×Tan/Yi.

In an implementation, the function is: Gi=d×(1−c)×Yi/(c×(d−1))+(c×d−1)/(c×(d−1)).

In an implementation, the function is logarithmic: Gi=1/c+(1−c)×log(Yi)/(c×log(d)).

It can be a simple comparison with a threshold value THR:

If Yi<THR then Gi=1
If Yi>THR then Gi=1/c

### Particular Case of Signals of Step 3 in Analysis Mode

To speed up the transfer time of the image to the electronic circuit, and/or the processing time, it is possible to make do with acquiring a fraction of the pixels of the image sensor. In practice, as explained in section 1.2, the useful information can concern only a group of pixels; it is therefore only necessary to acquire a single data item for each group of pixels.

Such an example is the use of the image sensor in “bining” mode (averaging of a number of adjacent pixels towards a single output data item).

### Exemplary Architecture of the Electronic Circuit

FIG. 5 represents the simplified architectural diagram of the electronic intelligence:

It comprises a multiplexer (30) receiving data from a memory (31) containing the recording control parameters, and a memory (32) containing the analysis control parameters (Tan, etc).

It also comprises a synchronization machine (33) delivering data to a second multiplexer (34).

A third multiplexer (35) receives the data from a filtering circuit (36) and from the modulator Gan (37).

A synchronization machine is synchronized with the image sensor (as master or as slave). It switches the signals according to the mode (analysis or recording).

In analysis mode:

“1”: A multiplexer (34) defines a uniform transmission rate for the “Gan” modulator (37).
“2”: A multiplexer defines the image sensor control parameters for the analysis mode (Tan, etc).
“3”: The signals Yi are switched by a multiplexer to a memory M1. They are then processed with the filtering transfer function (see 2.2).

In recording mode:

“1”: A multiplexer defines the filtering modulation from the processing derived from the filtering transfer function (36).
“2”: A multiplexer defines the image sensor control parameters for the recording mode.
“3”: The signals Yi are switched by a multiplexer to a memory M2 where they are stored for forwarding to the electronics for the visualization means.

Particular cases of signals “1” in analysis mode

In one case of implementation, all the groups of pixels Mi of the modulator are managed identically. In contrast, within a group, the pixels are managed differently. For example, all the pixels can be set to Vtmin, except one pixel set between Vtmin and Vtmax.

In one case of implementation, the signals “1” of an analysis mode are dependent on the signals “1” of the preceding recording mode. For example, if Girec<THR then Gian=1/c where THR is a threshold value.

### General Principle of the Second Operating Mode

The basic idea remains the same: a light modulator is controlled according to information from the own image sensor that it is protecting from glare. However, there are not two alternating modes as in the first operating mode, the principle being a constant active control with feedback.

In the “alternate” operating mode, the electronic intelligence determines the filtering modulation using an analysis phase.

In the feedback operating mode described here, there is no analysis phase; there is therefore only one operating mode, divided into cycles. This makes it possible to avoid having “ineffective time” periods in a cycle (such as the analysis phase) and therefore to have a maximum of useful time for the exposure time on the image sensor.

FIG. 6 represents the theoretical block diagram of the filtering module corresponding to this second operating mode.

The filtering modulation is determined according to the modulation applied in the preceding cycle and the information seen by the retina also in the preceding cycle.

Gi of the cycle n+1 depends on Gi of the cycle n and Yi of the cycle n:

Gi(n+1=A[Gi(n); Yi(n)]

A[ ] is the “filtering function” of this embodiment, the principle of which is given below (M1 and M2 are memories).

FIG. 7 represents the response curve of the filtering function.

The filtering circuit produces a representation by thresholding in order to determine whether the modulator needs to be passing (Gi=1) or blocking (Gi=1/c).

Assume two threshold levels S1 and S2:

If Yi(n)>S, then Gi(n+1)=1/c
If Yi(n)<S2, then Gi(n+1)=1

The threshold S1 is determined according to the required photometric characteristics.

The threshold S2 is defined according to S1 in order to ensure a good feedback: S2=S1/c−_{—}

_ being the hysteresis needed to avoid interference of the control function.

FIGS. 8 and 9 represent the thresholding table and the response curve corresponding to a number of filtering levels determined by different threshold levels.

FIG. 10 represents the operating algorithm of the device.

At the outset, the modulator is totally transparent, all the pixels being in passing mode.

There then follows the acquisition of an image n, and, at the same time, the reproduction on a visualization screen, and the analysis of the image, beginning with reading of the brightness level of a first pixel i.

If the state of the corresponding pixel is blocking, the brightness value is compared with a threshold value 2, and the state of this pixel is modified or maintained according to the result of the comparison.

If the state of the corresponding pixel is passing, the brightness value is compared with a threshold value 1, and the state of this pixel is modified or maintained according to the result of the comparison.

This processing is repeated for each pixel, which leads to an ongoing recalculation of the filtering provided by the modulator, during image acquisition.

This filtering can be performed with reference to a number of threshold values, as diagrammatically represented in FIGS. 11 and 12 corresponding to the thresholding table and the response curve.

1. An anti-glare device comprising a camera, a visualization means for reproducing a processed image and an adaptable filter presenting a filtering image, said image presenting masking regions obscuring the glare regions, characterized in that it comprises a single camera, the output of which is connected to an electronic circuit controlling the filter and reevaluating, in time, the filtering image according to an image acquired by said camera, said filter being placed in the focal plane of an input lens.

2. The anti-glare device as claimed in claim 1, characterized in that the electronic circuit controls the filter for the alternate display of an acquisition image and a filtration image calculated according to the image transmitted by the camera during the previous acquisition phase.

3. The anti-glare device as claimed in claim 2, characterized in that the circuit disables the transmission of the video signal from the camera to the visualization means during the acquisition phases.

4. The anti-glare device as claimed in claim 2, characterized in that the electronic circuit transmits to the visualization means, during the acquisition phases, a prerecorded image corresponding to the image transmitted by the camera before the acquisition phase.

5. The anti-glare device as claimed in claim 2, characterized in that the electronic circuit controls the filter during the acquisition phase, so that it presents a uniform transmission rate over the entire surface area, with a transmission value corresponding to a value Vt less than 1.

6. The anti-glare device as claimed in claim 5, characterized in that said value Vt is determined according to the brightness of at least one previous image.

7. The anti-glare device as claimed in claim 1, characterized in that the electronic circuit permanently controls the filter for the display of a filtering image, the control law being dependent:
on an image filtered by a filtering image calculated previously and seen by the camera, and
on the filtering image calculated previously.

8. The anti-glare device as claimed in claim 7, characterized in that said control law of the filter comprises at least one hysteresis cycle with two threshold levels.

9. The anti-glare device as claimed in claim 1, characterized in that the filter is a liquid crystal filter.

10. The anti-glare device as claimed in claim 9, characterized in that said filter is a reflection filter.

11. The anti-glare device as claimed in claim 10, characterized in that said filter is a transmission filter.

12. The anti-glare device as claimed in any claim 1, characterized in that the filter is a steerable micromirror filter.

13. The anti-glare device as claimed in claim 1, characterized in that the masking regions present a maximum transmission in a waveband.

14. The anti-glare device as claimed in claim 13, characterized in that said waveband corresponds to red.

15. A method of processing an image acquired by a camera, comprising a filtration step by a filter controlled by a masking image re-evaluated in time, a step during which the image is acquired by the camera after insertion of said filter controlled by the previously re-evaluated masking image, said filter being placed in the focal plane of an input lens and said re-evaluation being dependent on an image previously acquired by the camera.

16. The method as claimed in claim 15, characterized in that it comprises, alternately, a step for acquiring an image and analyzing said image to prepare a masking image, and said filtration step, the steps for acquiring images to control the filter and for reproducing the corrected image being performed by the same camera.

17. The method as claimed in claim 16, characterized in that the images reproduced during the step for acquiring the masking image correspond to a previous corrected image.

18. The method as claimed in claim 16, characterized in that the step for acquiring a filtration image is performed in a time less than the retinal persistence time.

19. The method as claimed in claim 15, characterized in that said re-evaluation comprises a step for calculating the new masking image according to a previously evaluated masking image and an image previously acquired by the camera and filtered by said previously evaluated masking image.

20. The method as claimed in claim 19, characterized in that said evaluation comprises a step consisting, for each pixel or group of pixels of said masking image:
in modifying the transmission rate to a more passing state if the luminance of the corresponding pixel or group of pixels of the filtered image previously acquired is less than a threshold S2,
in modifying the transmission rate to a less passing state if the luminance of the corresponding pixel or group of pixels of the filtered image previously acquired is greater than a threshold S1 greater than the threshold S2,
in retaining the transmission rate of said previously evaluated masking image if the luminance of the corresponding pixel or group of pixels of the filtered image previously acquired is between said thresholds S1 and S2.

21. An accessory of a photographic or video exposure device, for correcting the image acquired by an image sensor, characterized in that it comprises an active filter controlled by a masking image reevaluated in time by a circuit receiving the image acquired by the camera.

22. The accessory as claimed in claim 21, characterized in that said circuit receiving the image acquired by the camera periodically controls the presentation by the filter of a reference masking image during the phases for acquiring a new masking image.

23. The accessory as claimed in claim 22, characterized in that said circuit also disables the link between the image sensor and the output of the exposure device during the phases for acquiring the filtration image.

24. The accessory as claimed in claim 21, characterized in that said circuit receiving the image acquired by the camera re-evaluates the masking image according to the masking image previously used and the image recently acquired by the camera through the masking image previously used.
